(19) United States
(12) Patent Application Publication
(10) Pub. No.: US 2007/0104908 A1
(43) Pub. Date: May 10, 2007

(54) Architectural graphic system

(76) Inventors: Terry L Driscoll, West Bend, WI (US); Daniel P. Schettle, West Bend, WI (US); Linda E. Fechter, West Bend, WI (US)

Correspondence Address: GODFREY & KAHN S.C., 780 NORTH WATER STREET, MILWAUKEE, WI, 53202, US

(21) Appl. No.: 10/561,146

(22) PCT Filed: Jun. 16, 2003
(86) PCT No.: PCT/US03/19058

§ 371 Date: Dec. 16, 2005

(51) Int. Cl. B32B 33/00

(52) U.S. Cl. 428/40.1

(57) ABSTRACT

A decorating system for retail floor space and other architectural spaces or surfaces. The architectural graphic system (40) comprising a multi-layered decorated article (42) comprised of a stabilizing and masking polymeric layer (44) combined with a flexible transparent polymeric layer (46), a decoration layer (48), and an adhesive layer (50) preferably with a release liner (52) applied thereto. The architectural graphic system (40) may be modified to include a heat transfer architectural graphic system application wherein the adhesive (50) is preferably a thermally activated adhesive and the stabilizing/masking layer (44) may serve as a release liner.

### BACKGROUND OF THE INVENTION

The present invention relates generally to an architectural graphic system for surface decoration of a retail environment and difficult to decorate consumer goods. In particular, the present invention relates to an economical decorating system for retail floor space and any other architectural space or surface that would benefit from the graphic system of the present invention. The present invention also exhibits a particularly good fit as a decorating system for heat transfer of decorative graphics onto consumer goods or other surfaces.

Architectural decoration typically includes painting or applying wall paper or tile to walls, applying carpeting or tile to floors, and painting or applying tile to ceilings. These decoration systems are of a permanent nature due to the cost of application and/or difficulty of removal. Tradeshows, businesses, schools, stadiums, museums, theaters, auditoriums, public areas, homes, buses, planes, boats, motor cycles, and the like usually apply decorating schemes that are permanent in nature and made up of multiple smaller graphics that are often ineffective and expensive to change. Seasonal, advertising and merchandising decoration typically includes signs, stickers, decals, floor graphics and the like that are often cumbersome and labor intensive to apply and remove. Floors and other architectural surfaces are commonly decorated with graphics or advertising.

Advertising decorating systems for retail floor space have been a fast growing market for the past ten years. Advertising decorating systems often include floor graphics, which are applied to the floor of a retail operation and contain advertising and/or attention grabbing graphics to promote specific merchandise.

Floor graphics have been patented for the risers of stairs to make use of this advertising space, see U.S. Pat. No. 6,041,533 to Lemmond Jr. et al. Simulated three-dimensional floor graphics have also been patented in U.S. Pat. No. 6,197,405 to Johnsen et al. and lenticular or stereoscopic floor graphics are described in pending U.S. patent application Ser. No. 10/325,065 to Scarbrough et al. and assigned to the assignee of the present invention. An example of a prior art floor graphic system is shown in FIG. 1.

FIG. 1 illustrates an enlarged cross-sectional view of a prior art floor graphic 10. A typical floor graphic 10 comprises a main substrate 12 with a graphic element 14 applied to a top surface 16 of the substrate, often through offset printing, flexography, digital or screen printing. The main substrate 12 also typically includes a pressure sensitive adhesive layer 18 applied to a bottom surface 20 of the substrate opposite the graphic layer 14. The adhesive layer 18 is specifically formulated to adhere to retail floor space without any loose edges for consumers to trip over, withstand multiple cleaning and/or waxing events, and be removed when desired with little or no adhesive residue remaining on the floor. The floor graphic 10 is typically produced with a protective release liner 22 to protect the adhesive layer 18 during manufacturing and distribution. When the floor graphic 10 is to be applied to the floor, the release liner 22 is removed from the adhesive layer 18 and the floor graphic 10 is applied to the floor. The top surface of the floor graphic 10 is typically covered with a protective transparent layer 24. This surface protective layer 24 has multiple purposes. It must be transparent enough to allow the graphic to be seen. This layer 24 may have an additional decorative properties such as adding small metal flakes to the material to impart a glitter effect over the entire graphic. This layer 24 also typically requires a specific surface coefficient of friction. This coefficient of friction insures a non-skid characteristic of the floor graphic to prevent consumers from slipping on the floor graphic. The floor graphic exhibits non-slip characteristics when dry and even when wet. This non-skid surface 24 is typically mounted to the floor graphic with an adhesive layer 26. The adhesive layer 26 is usually a pressure sensitive adhesive pre-applied to the appropriate surface of the non-skid material 24 or a thermal transfer adhesive applied to the appropriate surface of the non-skid material 24. With the pressure sensitive adhesive, the non-skid layer 24 is typically applied with a cold laminator. With the thermal transfer adhesive, the non-skid layer 24 is typically applied with a thermal laminator.

There are many variations of floor graphics available. In another embodiment, a separate layer may be printed and a non-skid surface applied over this layer. The non-decorated surface of the separate layer may subsequently have an adhesive applied to one surface thereof designed to be applied to the floor and the adhesive covered with a protective release liner.

The floor graphic can be in the form of footsteps, arrows or the like pointing the way to a particular item or as an advertisement on the floor space directly in front of the advertised item. Floor graphics are typically limited to manageable sizes. They need to be manufactured and applied which implies certain size restrictions. The application process is particularly relevant to the size. The adhesive makes the ease of application of the graphic dependent on size. Large floor graphics are difficult to apply because entrapment of air bubbles between the floor and the graphic are more likely to occur with larger graphics. Large floor graphics also are difficult to handle and during application it is difficult to apply the graphic without it being wrinkled.

Heat transfers are typically a decoration or a graphic system that is constructed on a carrier material and transferred or applied to an article to be decorated. The carrier material is typically paper or plastic. The carrier contains a layer for the easy release of the decoration or graphic from the carrier to the article to be decorated.

FIG. 2 illustrates an enlarged cross-sectional view of a prior art heat transfer floor graphic 30. A typical heat transfer floor graphic 30 comprises a decorative graphic element 32 applied to a release layer 34 of a carrier 36 with normal decorating technologies such as flexography, serigraphy, lithography and digital printing. The graphic layer 32 may include a protective layer 38 applied to one surface of the graphic that is made of a special polymer designed for weather resistance, abrasion resistance, washing machine cycle resistance and the like. The graphic layer 32 is also covered with an adhesive layer 28 on a surface of the graphic opposite the protective layer 38. The release layer 34 is specifically designed to release the graphic element 32 onto the article to be decorated under the conditions designed for the article. The conditions vary depending on the heat transfer temperature, the surface and flat or curved nature of the article to be decorated, and the type and material of the article itself. The adhesive layer 28 is designed to affix the graphic element 32 to the article to be decorated under the conditions designed for the article. The adhesive of the adhesive layer 28 is typically a heat activated adhesive that under the application of heat becomes tacky and bonds the graphic layer 32 to the article to be decorated.

Numerous variations of a heat transfer floor graphic have been developed. In one embodiment, the release layer may be designed to release from the carrier and remain on the surface of the graphic when applied to an article to be decorated. The release layer may be comprised of a special polymer that includes additional decorative properties or performance enhancements such as glitter, opalescence, iridescence, weather resistance, and/or abrasion resistance. The heat activated adhesive layer may be covered with a protective release liner, to protect the adhesive during manufacturing, distribution and handling operations until application. The protective release liner may also prevent the adhesive from prematurely adhering to any other surface it may come in contact with prior to application.

The present invention satisfies a need that exists for an economical architectural graphic system that is easy to apply and remove, and overcomes the problems or disadvantages of prior art systems.

### SUMMARY OF THE INVENTION

The present invention is an architectural graphic system for decorating retail floor space and other architectural spaces and surfaces. The system comprises a multilayer decorated article comprises a stabilizing/masking polymeric layer combined with a transparent polymeric layer, such as SeriClear™, SeriClearII™, or SeriClearIII™, manufactured by Serigrpah Inc. of West Bend, Wis. The decorated article further comprises a graphic decoration layer applied to at least one surface of the flexible transparent polymeric layer, and an adhesive layer preferably protected with a release liner applied to at least one surface of the decoration layer.

In one embodiment of the present invention, the architectural graphic system comprises a multilayer decorated article including a stabilizing/masking polymeric layer combined with a flexible transparent polymeric layer, a graphic decoration layer, and an adhesive layer preferably protected with a release liner.

In another embodiment of the invention, a heat transfer architectural graphic system comprises a stabilizing/masking polymeric layer combined with a flexible transparent polymeric layer, a graphic decoration layer, and an adhesive layer preferably protected with a release liner. In heat transfer applications the adhesive is preferably a thermally activated adhesive. Also, the stabilizing/masking layer may serve as a release liner.

In yet another embodiment of the present invention, a heat transfer architectural graphic system comprises a multilayer decorated article including a stabilizing/masking polymeric layer combined with a flexible transparent polymeric layer, a graphic decoration layer, a white film or ink layer, and an adhesive layer preferably protected with a release liner.

The present invention also contemplates a method of manufacturing an architectural graphic system in accordance with the embodiments of the present invention to create a final product in a manner and with materials not possible without the transparent flexible layer and the stabilizing/masking layer innovations.

The system of the present invention exhibits unique properties to open an entirely new field of use for graphically decorated articles to be used as an economical, permanent or disposable, decorating system for consumer, industrial, commercial,. and other applications. The article may be used for decorating retail environments, office space, public areas, stores, schools, museums, theaters, auditoriums, gymnasiums, stadiums, arenas, businesses, homes, sidewalks, ATVs, RVs, buses, planes, watercraft, snowmobiles, motorcycles, motors, lawn and garden equipment, indoor and outdoor power equipment, golf clubs, fishing reels, fishing poles and the like can be decorated with multi-colored, specific colored or advertising decorating schemes that can be replaced or altered at little cost. The potential in decorating, advertising, branding, and merchandising is now much broader due to the economical and ease of process possibilities of this invention.

The system also possesses desirable properties as a heat transfer system of decorative graphics to similarly complex surfaces and numerous other end uses that take advantage of the flexibility, conformability, reposition-ability of the construction, low temperature transference in heat transfer applications, flexibility to undergo concurrent temperature or other related dimensional fluctuations on the surfaces it is applied to, adjustable gloss for super high, moderate or low gloss surfaces, abrasion resistant surface, weather resistant article if desired, floor wax compatible surface, and non-skid surface to satisfy safety concerns for applications covering floor surfaces.

Various other features, objects, and advantages of the invention will be apparent to those skilled in the art from the following drawings and detailed description of the invention.

### BRIEF DESCRIPTION OF THE DRAWINGS

FIG. 1 is an enlarged cross-sectional view of a prior art floor graphic;

FIG. 2 is an enlarged cross-sectional view of a prior art heat transfer floor graphic;

FIG. 3 is an enlarged cross-sectional view of an architectural graphic system in accordance with an embodiment of the present invention;

FIG. 4 is an enlarged partial planar cross-sectional view of a heat transfer architectural graphic system in accordance with another embodiment of the present invention;

FIG. 5 is an enlarged partial planar cross-sectional view of an architectural graphic system in accordance with yet another embodiment of the present invention;

FIG. 6A is a perspective view of a retail environment illustrating the use of an embodiment of the present invention; and

FIG. 6B is a perspective view of a retail environment illustrating the use of another embodiment of the present invention.

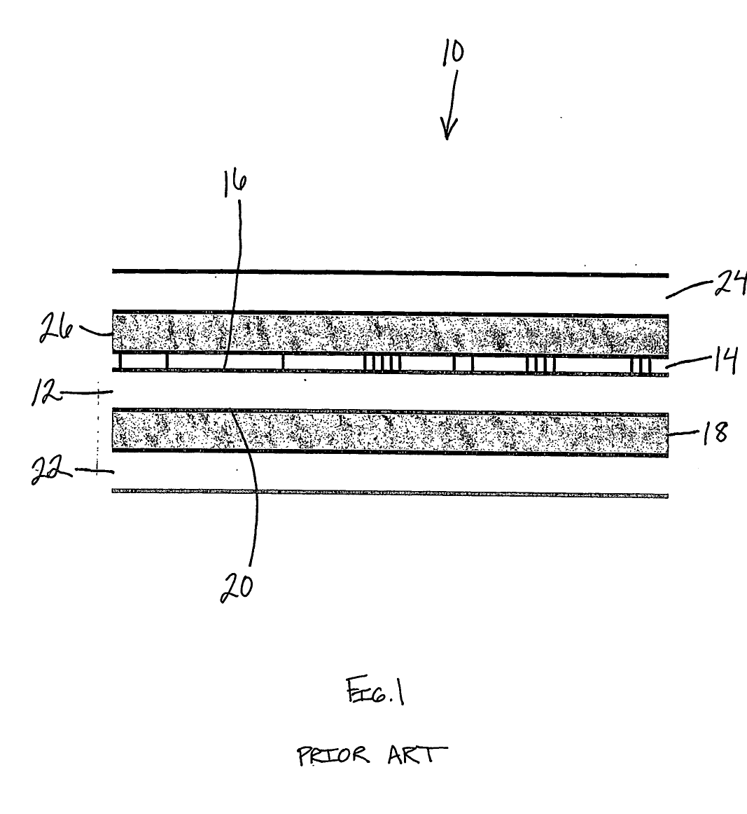

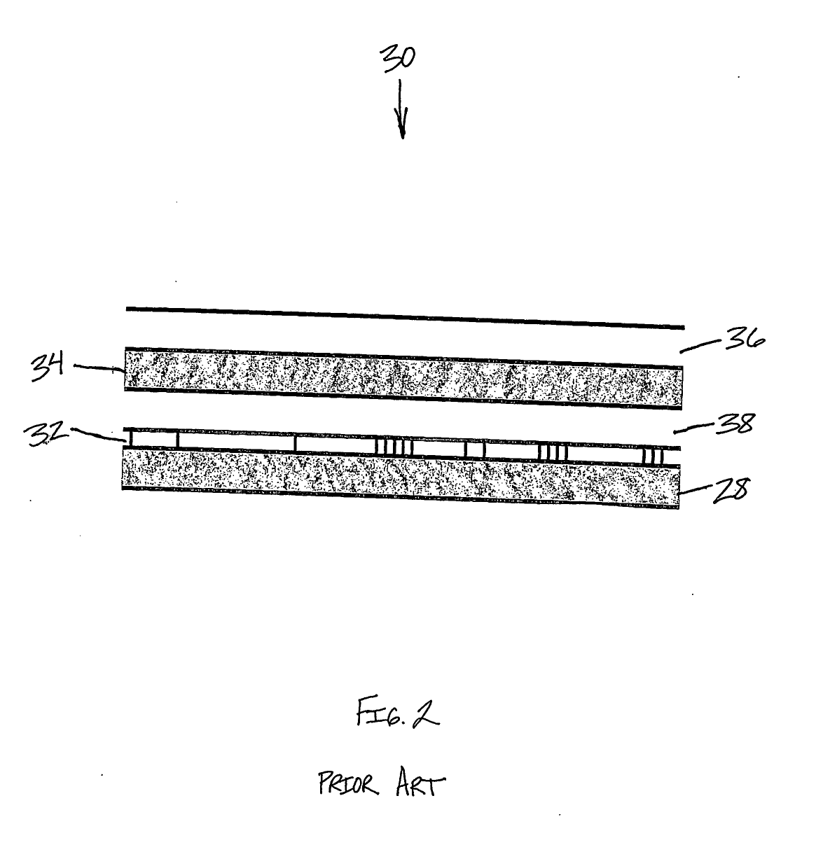

### DETAILED DESCRIPTION OF THE INVENTION

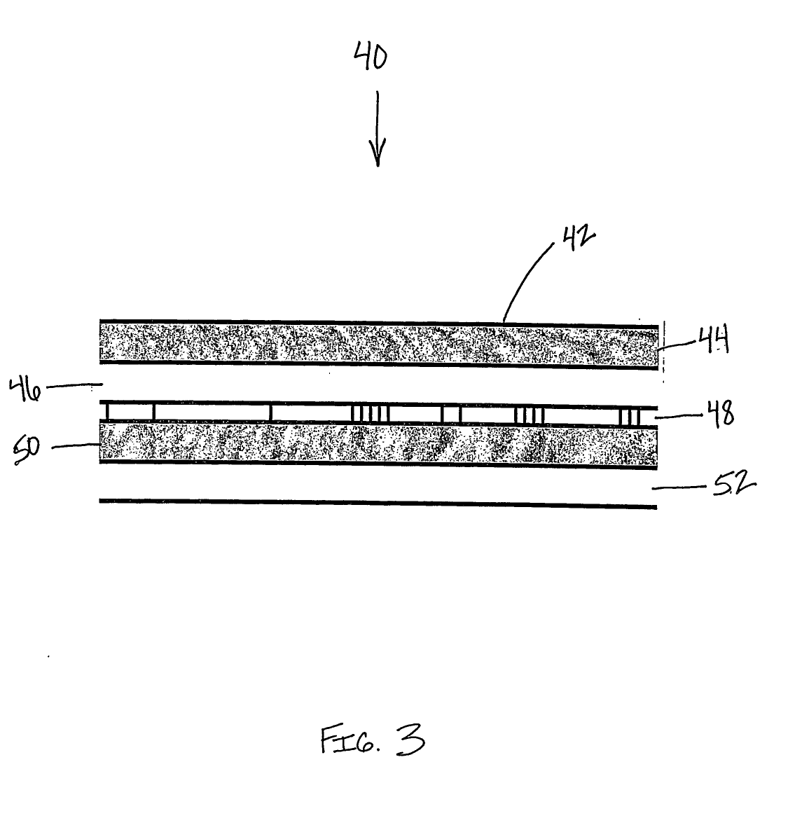

Referring now to the drawings, FIG. 3 illustrates an enlarged cross-sectional view of an embodiment of an architectural graphic system 40 of the present invention. The system 40 comprises a multilayer decorated article 42 including a stabilizing/masking polymeric layer 44 combined with a flexible transparent polymeric layer 46, a graphic, preferably four color process printed in conjunction with specific color matches if desired, decoration layer 48 applied to at least one surface of the flexible transparent polymeric layer 46, and an adhesive layer 50 protected with a release liner 52 that is preferably applied to at least one surface of the decoration layer 48.

The article 42 exhibits unique characteristics that make it highly desirable for a complete floor decoration system, a discrete graphic advertisement system for floor space (floor graphics), and other architecturally complex surfaces such as ATVs, RVs, buses, planes, watercraft, snowmobiles, motorcycles, motors, lawn and garden equipment, indoor and outdoor power equipment, golf clubs, fishing reels, fishing poles and the like.

In a preferred embodiment, the transparent polymeric layer 46 is manufactured from a very soft flexible vinyl such as SeriClear™ manufactured by Serigrpah Inc. of West Bend, Wis. Alternatively, the flexible transparent polymeric layer 46 may be manufactured from a non-vinyl material such as SeriClearII™ or SeriClearIII™ also manufactured by Serigrpah Inc. of West Bend, Wis. The flexible transparent polymeric layer 46 is preferably designed to conform to complex curved surfaces. The flexibility of the transparent flexible layer 46 is such that even irregular shapes can be conformed to without wrinkles and it has the strength to resist eventual lifting off of any of the surfaces to which it is applied.

The flexible transparent polymeric layer 46 is preferably designed to possess non-skid surface characteristics, similar to properties required for floor graphic applications. The polymer preferably possesses the strength and flexibility to undergo the stress of application, dimensional changes after application due to temperature and humidity fluctuations that occur on floors, ceilings, walls, windows, contoured surfaces, and removal. The flexible transparent polymer is also designed to prevent transmission of water, wax, and cleaning solutions, which may alter the graphics or even stain the surface under the decorated graphic. The transparent flexible polymer is preferably designed with polymeric plasticizers to impart the flexibility required and prevent migration, common with monomeric plasticizers, of the plasticizer from this layer into any other layer of the construction or even into the atmosphere with potentially undesirable effects.

The flexible transparent polymeric layer 46 may also be decorated by a printing process including screen, offset, digital, flexography, gravure or any other decorating process. In addition, weather resistant, anti-static, anti-friction, anti-skid, and/or ultraviolet light barrier properties for fade resistance can easily be incorporated into the flexible transparent polymeric layer 46 by processes known in the art.

The flexible transparent polymeric layer 46 can be designed with low, moderate, or in the preferred embodiment, a super gloss surface. The super-gloss surface is produced by combining the flexible transparent polymeric layer 46 with a super high gloss finish of the stabilizing/masking layer 44. This would preferably be produced by casting the transparent flexible polymer directly onto the stabilizing/masking layer 44 in solution form under typical cast film manufacturing processes, or laminating the transparent flexible polymer to the stabilizing/masking layer 44 under pressure. Thus, the flexible transparent polymeric layer 46 will have a surface mirroring the surface of stabilizing/masking layer 44. In moderate or low gloss situations, the surface of the stabilizing/masking layer 44 in contact with the flexible transparent polymeric layer 46 is low or moderate gloss which is mirrored by the flexible transparent polymeric layer 46. Alternatively, the lower gloss could be achieved through the addition of matting ingredients into the transparent polymer that when incorporated exhibit a roughness on the surface which scatters reflected light. Super high gloss surfaces are very difficult to accomplish and difficult to protect during subsequent handling. Rigid polymers, which are contrary to many end uses requiring flexibility, or gloss coatings, which are expensive, are current methods to achieve high gloss. Flexible polymers with high gloss are difficult to handle as they are easily damaged during manufacturing and handling operations. In the present invention, the gloss is preferably obtained by contact of the flexible transparent polymeric layer 46 with the stabilizing/masking layer 44. The flexible transparent polymeric layer 46 is protected during manufacturing and subsequent handling by the same stabilizing/masking layer 44.

The desired characteristics of the flexible transparent polymeric layer 46 without the stabilizing/masking layer 44 result in a film that web and sheet fed printing operations have difficulty manufacturing. However, new highly sensitive controlled web printing operations and many digital printing machines may overcome these difficulties, but the scratching and marring of the surface during subsequent shipping and handling would make application difficult. To facilitate the manufacture of this polymer through common web printing operations and sheet fed printing operations, the stabilizing/masking layer 44 is preferably used in conjunction with the flexible transparent polymeric layer 46. The stabilizing/masking layer 44 provides a protective cover against scratching and other damage to the flexible transparent polymeric layer 46 during manufacture and application processes.

The adhesive layer 50 applied to the bottom surface of the graphic decorated layer 48 is preferably a pressure sensitive adhesive with good removable characteristics. The removeability of the adhesive is matched with the strength of the transparent polymeric layer 46 and the surface of the article to be decorated, such that the adhesive yields or releases before the transparent polymeric layer 46 destructs to ease removal operations. The adhesive layer 50 is also preferably designed to withstand water, waxing, cleaning and other harsh solutions during the anticipated life of the application. The adhesive layer 50 is preferably produced with a protective release liner 52 to protect the adhesive during manufacturing, handling and distribution. When the decorated article 42 is to be applied, the release liner 52 is removed from the adhesive layer 50. The adhesive layer 50 is preferably designed to adhere to a surface to be decorated without any loose edges and to withstand multiple cleaning and/or waxing events, and be removed when desired with little or no adhesive residue remaining on the decorated surface.

The adhesive is preferably white, however, a clear adhesive may be used for those applications where the surface it is affixed to is preferred to be viewed through the decorated article. It is also possible to use colored adhesives for various effects.

Numerous variations of the architectural graphic system 40 of FIG. 3 are contemplated in the present invention. For example, a web decorating process could print the flexible transparent polymeric layer 46 without the stabilizing/masking layer 44 in applications where the surface protection and masking performance of the stabilizing/masking layer 44 is not required. Or, the current preferable vinyl polymer of the flexible transparent polymeric layer 46 could be replaced with polymeric material other than vinyl, depending on the end use requirements. In addition, graphic decoration could be applied to the opposite surface of a substrate with the requisite performance, followed by the application of a protective layer, if desired, and a matching adhesive layer could be applied to the opposite or non-decorated surface. Also, the decorated article 42 could contain a heat activated layer instead of the pressure sensitive adhesive layer for heated applications.

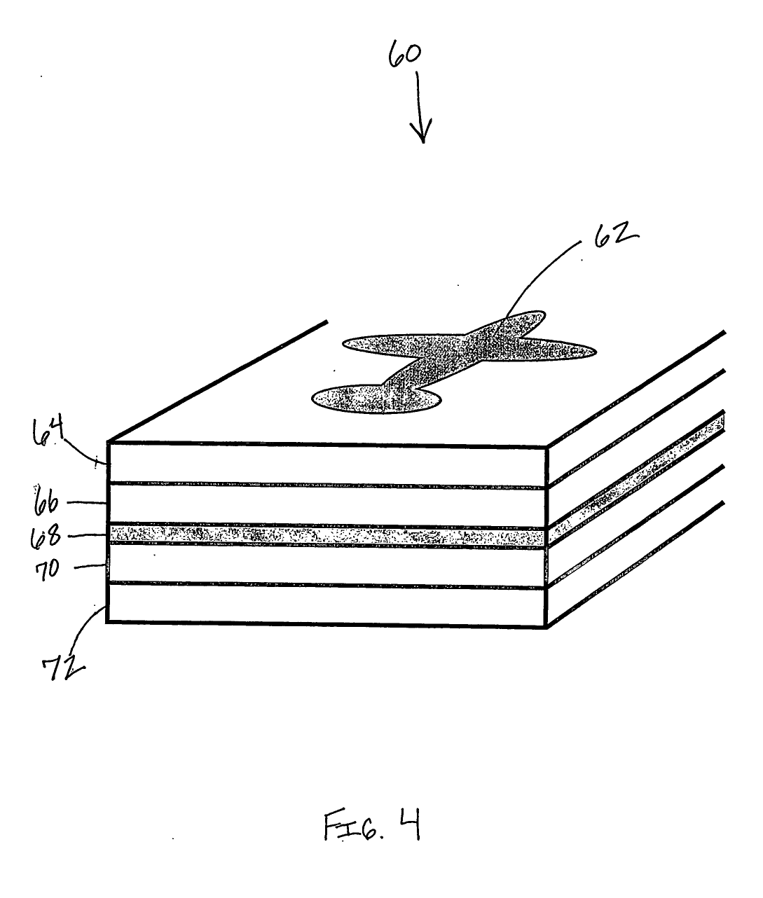

FIG. 4 is an enlarged partial planar cross-sectional view of a heat transfer architectural graphic system 60 in accordance with another embodiment of the present invention. The heat transfer architectural graphic system 60 includes the same essential layers as shown in the embodiment of FIG. 3, but modified for heat transfer applications of a decorative graphic applied to surfaces where a heat transfer method of application is desired.

The system 60 comprises a multilayer decorated article 62 including a stabilizing/masking polymeric layer 64 combined with a flexible transparent polymeric layer 66, a graphic decoration layer 68 applied to at least one surface of the flexible transparent polymeric layer 66, and an adhesive layer 70 preferably protected with a release liner 72 that is applied to at least one surface of the decoration layer 68. The stabilizing/masking polymeric layer 64 is preferably a polyester between one and five thousandths of an inch thick. The flexible transparent polymeric layer 66 is preferably a plasticized vinyl that is three and a half thousandths of an inch thick. Low friction and anti static characteristics are preferably added to the polymer layers to enable efficiency and ease of manufacture. The stabilizing/masking layer 64 is preferably combined with the flexible transparent polymeric layer 66 with a laminating process or a standard cast coating method. This multilayer polymer is subsequently printed using standard printing processes. In a preferred embodiment, offset lithography provides excellent resolution and manufacturing economies for large quantity print runs. The flexible transparent layer of the multilayer polymer is preferably printed with UV inks for high speed manufacturing and environmental concerns. In heat transfer applications, the stabilizing/masking layer 64 may also serve as a release liner.

The graphic decoration layer 68 is preferably backed with a pressure sensitive adhesive layer 70 to impart excellent color brilliance and to prevent the colors of any surface that the decorated article is applied to from showing through the graphic decoration and altering the appearance. The pressure sensitive adhesive layer 70 is also preferably a polymer that is protected by a release liner 72. The pressure sensitive adhesive layer 70 is preferably white, however, the adhesive layer 70 may be clear for those applications where the surface it is affixed to is preferred to be viewed through the decorated article, or the adhesive layer may be colored to produce various desired effects. The adhesive layer 70 has the performance characteristics for application to a surface to be decorated. Alternatively, the adhesive layer could be replaced with a white polymer film that is coated on the opposite surface with a matching adhesive for application to the substrate. If the white polymer film is alternatively an ink, a subsequent layer of adhesive is applied with a standard coating or printing technique or another multilayer polymer comprising an adhesive or a film adhesive combination. In heat transfer applications, the adhesive is preferably a thermally activated adhesive.

The release liner 72 preferably protects the adhesive layer 70 from contamination during manufacturing, handling, distribution and application. Release liners typically are plastic or paper layers with a silicone coating on the surface against which the adhesive is to be in contact. The type of silicone will determine the force required to peel off the decorative article from the liner. The release liner 72 is removed when the decorated article 62 is applied to a surface to be decorated. After application, the stabilizing/masking layer 64 which has done its job of stabilizing the transparent flexible layer 66 through the printing operations, protecting the surface of the decorated graphic 68 and imparting the desired gloss level to the surface of the flexible transparent layer 66, can be removed before or after the decorated article 62 is applied to a surface to be decorated.

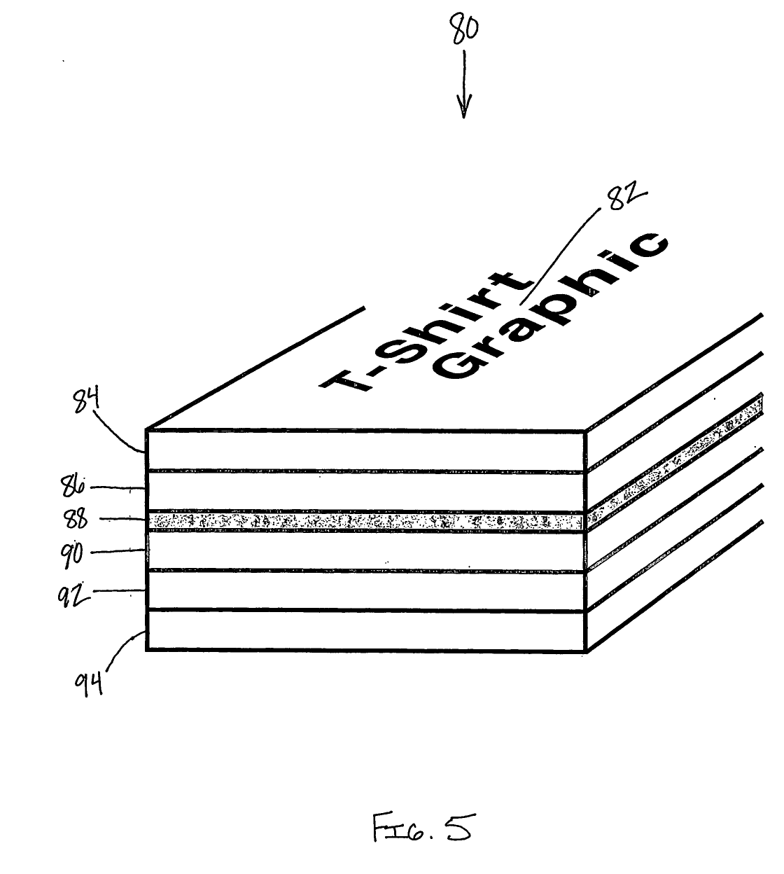

FIG. 5 is an enlarged partial planar cross-sectional view of another heat transfer architectural graphic system 80 in accordance with yet another embodiment of the present invention. The architectural graphic system 80 comprises a multilayer decorated article 82 including a stabilizing/masking polymeric layer 84 combined with a flexible transparent polymeric layer 86, a graphic decoration layer 88 applied to at least one surface of the flexible transparent polymeric layer 66, a white film or ink layer 90, and an adhesive layer 92 preferably protected with a release liner 94.

As mentioned above, the white film or ink layer 90 is subsequently coated preferably using a screen printing process with the heat activated adhesive layer 92. This heat activated adhesive layer 92 is specifically designed for each end use. The heat activated adhesive 92 is subsequently covered with the protective release liner 94 for subsequent manufacturing and handling until the heat transfer is to be applied, at which time the protective release liner 94 is removed. The heat activated adhesive surface 92 is placed in contact with a surface to be decorated and under heat and pressure the multilayer decorated article 82 is applied to the surface and the stabilizing/masking layer 84 is removed. In heat transfer applications, the stabilizing/masking layer 84 may also serve as a release liner.

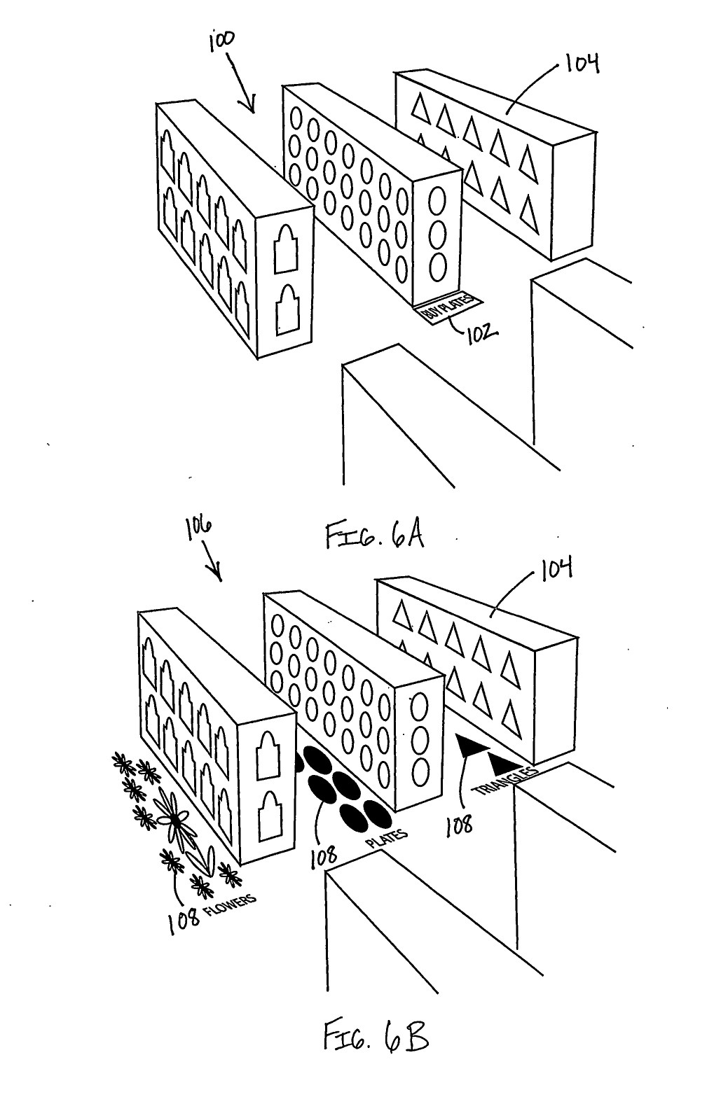

FIG. 6A is a perspective view of a retail environment 100 demonstrating the use of the present invention. The present invention with its various embodiments can be used to decorate aisles, floors, walls, ceilings, posts, columns, etc. FIG. 6A shows an architectural graphic system 102 being used to decorate the floor in front of goods on retail shelving 104. FIG. 6B is a perspective view of a retail environment 106 demonstrating the use of another embodiment of the present invention. FIG. 6B shows an architectural graphic system 108 being used to decorate the aisles of goods between retail shelving 104.

The present invention also contemplates a method of manufacturing an architectural graphic system in accordance with the embodiments of the present invention to create a final product in a manner and with materials not possible without the transparent flexible layer and the stabilizing/masking layer innovations.

The present invention exhibits unique properties to open an entirely new field of use for graphically decorated articles to be used as an economical, permanent or disposable, decorating system for consumer, industrial, and commercial applications. Entire floors in stores, schools, museums, theaters, auditoriums, public areas, stadiums, businesses, homes, buses, planes, watercraft, and the like can be decorated with multi-colored, specific colored or advertising decorating schemes that can be replaced or altered at little cost. The potential in decorating, advertising, branding, and merchandising is now much broader due to the economical possibilities of this invention.

The end use of the decorative graphic is for large floor space decoration applications such as seasonal or semi-permanent decoration of retail environments, office space, stadiums, arenas, schools, museums, theaters, homes, sidewalks, gymnasium floors, watercraft, motors, lawn and garden equipment, indoor and outdoor power equipment, golf shafts, fishing poles, and any other article in which the flexibility of the decorative graphic requires a flexible transparent polymer which must be married to a stabilizing layer to resist dimensional changes and mechanical stiffness for manufacturing operations not inherent in the flexible transparent polymer itself.

There are numerous innovations in printing technology that can be incorporated into the new decorative graphic system of the present invention. The incorporation of any of the following into the aforementioned decorative graphic system would still be based on the inherent performance of the stabilizing/masking layer combined with the flexible transparent layer as a base for the manufacturing operations.

For example, the addition of holographics, pearlescent, color changing films, inks, coatings to the construction as described in U.S. Pat. Nos. 5,082,703, 4,933,218, 5,106,126.

The addition of textures and/or opaque areas followed by reflective, pearlescent, holographic, metallic layer to impart textures and additional layers of depth and dimension to the decorative graphic article as described in U.S. Pat. No. 6,170,881 to Salmon et al. and U.S. patent application Ser. No. 60/192,051 to Scarbrough et al.

The incorporation of lenticular, three-dimensional, fish eye, and other depth and dimension technologies as described in U.S. Pat. No. 6,197,405 to Johnsen et al. and lenticular or stereoscopic graphics described in U.S. patent application No. 10/325,065 to Scarbrough et al.

While the invention has been described with reference to preferred embodiments, it is to be understood that the invention is not intended to be limited to the specific embodiments set forth above. It is recognized that those skilled in the art will appreciate that certain substitutions, alterations, modifications, and omissions may be made without departing from the spirit or intent of the invention. Accordingly, the foregoing description is meant to be exemplary only, the invention is to be taken as including all reasonable equivalents to the subject matter of the invention, and should not limit the scope of the invention set forth in the following claims.

1. An architectural graphic system comprising:
a decorative graphic article;
a thermal and mechanical dimensionally resistant polymer;
a flexible transparent polymer married to the thermal and mechanical dimensionally resistant polymer;
wherein the thermal and mechanical dimensionally resistant polymer acts to impart stability to the flexible transparent polymer through a decorating processes that involves heat and/or mechanical stress;
wherein the thermal and mechanical dimensionally resistant polymer also acts to protect the surface of the flexible transparent polymer from scratches and abrasions during the manufacturing and handling operations up to and potentially including installation or application of the architectural graphic system onto a surface to be decorated; and
a pressure sensitive adhesive applied to the decorative graphic article.

2. The system of claim 1 further comprising a release liner applied to the pressure sensitive adhesive.

3. The system of claim 1 wherein the pressure sensitive adhesive is transparent, white or colored to produce various effects.

4. The system of claim 1 wherein the pressure sensitive adhesive is replaced with a thermal adhesive.

5. The system of claim 4 further comprising a release liner applied to the thermal adhesive.

6. The system of claim 4 wherein the thermal adhesive is transparent, white or colored to produce various effects.

7. The system of claim 1 wherein the surface of the thermal and mechanical dimensionally resistant polymer not in contact with the flexible transparent polymer is constructed to provide an easy release of the pressure sensitive adhesive.

8. The system of claim 7 wherein the surface of the thermal and mechanical dimensionally resistant polymer not in contact with the flexible transparent polymer is coated with a silicone or other release coating.

9. The system of claim 7 wherein the pressure sensitive adhesive is applied to the decorative graphic article and is not protected by a release liner.

10. The system of claim 7 wherein the construction of the system is self-wound as a web or sheeted with a plurality of layers such that a pressure sensitive adhesive surface is directly in contact with the surface of the thermal and mechanical dimensionally resistant polymer not in contact with the flexible transparent polymer.

11-13. (canceled)

14. The system of claim 1 wherein the decorative graphic is an in-mold decoration where the graphic is placed into a mold tool and resin injected into the mold is permanently bonded to the graphic such that the graphic becomes an integral part of the final product.

15. The system of claim 1 further comprising additional layers of texture, metal, holographics, pearlescent pigments or films, iridescent pigments or films that are incorporated into any layer of the construction to impart additional graphic impact.

16. The system of claim 1 wherein the flexible transparent polymer is replaced by a lenticular layer such that the subsequent decorative graphic when viewed after application is three-dimensional or displays multiple images when viewed at different angles.

17. The system of claim 1 wherein the thermal and mechanical dimensionally resistant polymer is replaced by a lenticular layer, which is not removed after application, such that the subsequent decorative graphic when viewed after application is three-dimensional or displays multiple images when viewed at different angles.

18. The system of claim 1 wherein the adhesive layer is selectively applied to the flexible transparent layer, wherein the adhesive layer selectively bonds to a non-pressure sensitive layer and further includes a pressure sensitive adhesive layer such that additional decorative graphics could be easily inserted in-between the flexible transparent layer and the non-pressure sensitive layer which includes the pressure sensitive adhesive layer for application to the article.

19. The system of claim 18 wherein the area in-between the flexible transparent layer and the non-pressure sensitive layer forms a pocket which requires all or parts of the flexible transparent layer not be decorated such that the inserted decorative graphic is visible when the decorative graphic pocket is applied to the article to be decorated.

20. The system of claim 1 wherein the thermal and mechanical dimensionally resistant polymer is not used because the architectural graphic system will be decorated with graphics in web form where the stability of the thermal and mechanical dimensionally resistant polymer is not required, or decorated by a digital printing process where the stability of the thermal and mechanical dimensionally resistant polymer is not required.

21. The system of claim 20 wherein the masking requirement of the thermal and mechanical dimensionally resistant polymer is also not required.

22. The system of claim 20 wherein the flexibility, dimensional pliability, weather resistance, abrasion resistance, floor wax compatibility, cleaning or other harsh chemical resistance of the flexible transparent polymer is required.

23. A multilayer decorated article comprising:
a thermal and mechanical dimensionally resistant polymer;
a flexible transparent polymer married to the thermal and mechanical dimensionally resistant polymer with the appropriate transparency and flexibility to perform in the described end uses;
wherein the flexibility required is such that manufacturing operations will still require the thermal and mechanical dimensionally resistant polymer to be married to the transparent flexible polymer; and
wherein the decorated article after the decorating and graphic applying operations is applied to a pressure sensitive adhesive.

24-46. (canceled)
